(19) United States
(12) Patent Application Publication
(10) Pub. No.: US 2023/0162100 A1
(43) Pub. Date: May 25, 2023

(54) COMBINED PASSENGER AND FREIGHT TRANSPORT SYSTEM, VEHICLE DISPATCH DEVICE THEREIN, AND VEHICLE DISPATCH METHOD THEREIN

(71) Applicant: Nissan Motor Co., Ltd., Kanagawa (JP)

(72) Inventors: Naoki Kojo, Kanagawa (JP); Shigeki Satou, Kanagawa (JP)

(73) Assignee: Nissan Motor Co., Ltd., Kanagawa (JP)

(21) Appl. No.: 17/632,741

(22) PCT Filed: Jan. 28, 2021
(86) PCT No.: PCT/JP2021/003077

§ 371 Date: Feb. 3, 2022

(51) Int. Cl. G06Q 10/047; G06Q 50/30; G06Q 10/0835

(52) U.S. Cl. CPC G06Q 10/047; G06Q 50/30; G06Q 10/08355; G08G 1/127

(57) ABSTRACT

A vehicle dispatch device in a combined passenger and freight transport system acquires a delivery request including a collection point and a delivery point of the package and a vehicle dispatch request including a boarding point and a drop-off point of the passenger, detects a candidate vehicle as a candidate of a service vehicle for transporting the package and the passenger, based on the collection point or the boarding point, calculates a candidate route where the candidate vehicle goes via the collection point and the delivery point when the passenger is not on board, for the detected candidate vehicle, sets the calculated candidate route, as a traveling route for transporting the package and the passenger, and dispatches the candidate vehicle of the candidate route set as the traveling route, as the service vehicle.

### TECHNICAL FIELD

The present invention relates to a vehicle dispatch device and a vehicle dispatch method in a combined passenger and freight transport system where a package and a passenger are put together and transported by a service vehicle, and a crew of the service vehicle performs collection and delivery work of the package.

### BACKGROUND ART

Patent Literature 1 discloses a conventional on-demand combined passenger and freight transport system that enables a person and a package to be put together and moved. The combined passenger and freight transport system disclosed in Patent Literature 1 determines a route for an operating vehicle based on passenger and package movement requests.

### CITATION LIST

### Patent Literature

Patent Literature 1: Japanese Unexamined Patent Application Publication No. 2017-220090

### SUMMARY OF INVENTION

### Technical Problem

However, the conventional on-demand combined passenger and freight transport system described above determines the order of passenger boarding and drop-off points and package collection and delivery points based on passenger and package movement requests. This leads to a situation where a passenger may be in the vehicle even though a crew of the vehicle is absent for collection and delivery of packages, and trouble, such as theft of a package or the vehicle, may occur.

The present invention has been proposed in consideration of the above-described situation. It is an object of the present invention to provide a vehicle dispatch device and a vehicle dispatch method in a combined passenger and freight transport system, capable of preventing a situation from occurring where a crew is absent from a vehicle for collection and delivery of packages while a passenger is on board and thus preventing trouble from occurring.

### Technical Solution

In response to the above issue, a vehicle dispatch device and a vehicle dispatch method in a combined passenger and freight transport system according to an aspect of the present invention acquire a delivery request and a vehicle dispatch request and detect a candidate vehicle based on a collection point of a package or a boarding point of a passenger. Then, based on the delivery request and the vehicle dispatch request, a candidate route is calculated for the candidate vehicle, in which the candidate vehicle goes via the collection point and a delivery point of the package when the passenger is not on board. Thus, the calculated candidate route is set as a traveling route, and the candidate vehicle of the candidate route set as the traveling route is dispatched as a service vehicle.

### Advantageous

According to the present invention, it is possible to prevent a situation from occurring where a crew is absent from a vehicle for collection and delivery of packages when a passenger is on board, thereby preventing trouble from occurring, such as theft of a package or the vehicle.

### BRIEF DESCRIPTION OF DRAWINGS

FIG. 1 is a block diagram illustrating a configuration of a combined passenger and freight transport system according to a first embodiment of the present invention.

FIG. 2 is a diagram for illustrating a method of setting a traveling route for package and passenger transport by a conventional combined passenger and package transport system.

FIG. 3 is a diagram for illustrating a method of setting a traveling route for package and passenger transport by the combined passenger and freight transport system according to the first embodiment of the present invention.

FIG. 4 is a flow chart illustrating a processing procedure of vehicle dispatch processing by the combined passenger and freight transport system according to the first embodiment of the present invention.

FIG. 5 is a diagram for illustrating a method of calculating a candidate route for package and passenger transport by the combined passenger and freight transport system according to the first embodiment of the present invention.

FIG. 6 is a flow chart illustrating a processing procedure of vehicle dispatch processing by a combined passenger and freight transport system according to a second embodiment of the present invention.

FIG. 7 is a diagram for illustrating a method of calculating a candidate route for package and passenger transport by the combined passenger and freight transport system according to the second embodiment of the present invention.

FIG. 8 is a diagram for illustrating a method of calculating a candidate route for package and passenger transport by the combined passenger and freight transport system according to the second embodiment of the present invention.

### DESCRIPTION OF EMBODIMENTS

### First Embodiment

A first embodiment to which the present invention is applied is described below with reference to the drawings. The same elements in the drawings are denoted by the same reference numerals, and the description thereof is omitted.

### Configuration of Combined Passenger and Freight Transport System

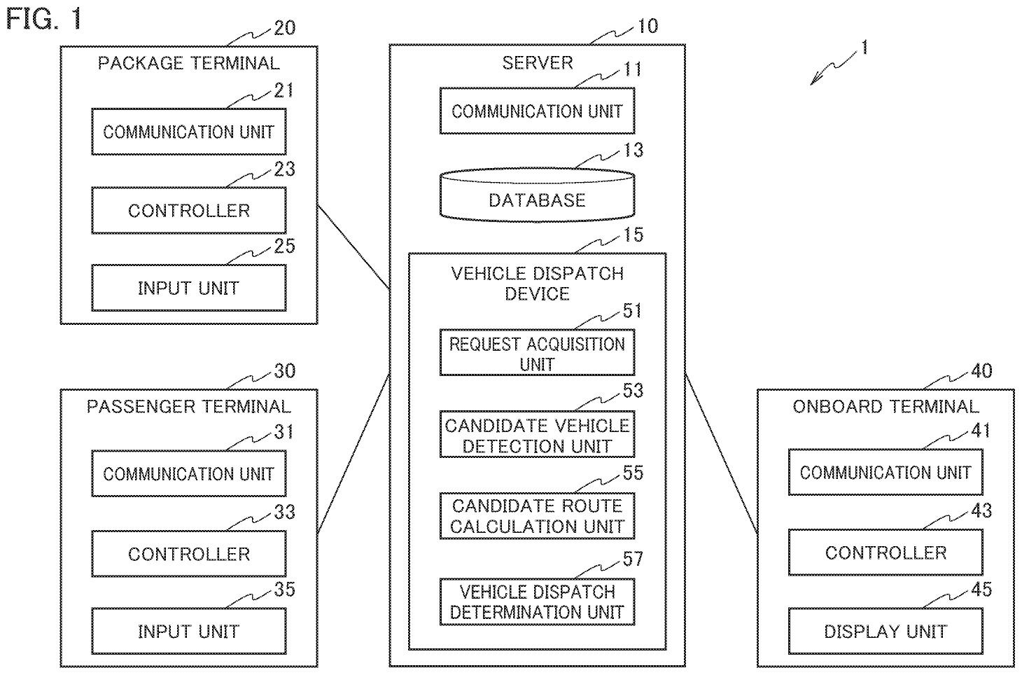

FIG. 1 is a block diagram illustrating a configuration of a combined passenger and freight transport system according to the present embodiment. As illustrated in FIG. 1, a combined passenger and freight transport system 1 according to the present embodiment includes a server 10 for managing service vehicles, a package terminal 20 for requesting delivery of a package, a passenger terminal 30 for requesting a ride on a service vehicle, and an onboard terminal 40 mounted on the service vehicle. The server 10 is connected to the package terminal 20, the passenger terminal 30, and the onboard terminal 40 through a wireless or wired network. The network is, for example, the Internet and may utilize a mobile communication function, such as 5G.

The combined passenger and freight transport system 1 is a system where a package and a passenger are put together and transported by a service vehicle, and a crew of the service vehicle, for example, a driver performs collection and delivery work of packages. A manager of a package who requests delivery of the package transmits a delivery request from the package terminal 20, and a passenger who wishes to get on a service vehicle transmits a vehicle dispatch request from the passenger terminal 30. When acquiring the delivery request and the vehicle dispatch request, the server 10 sets a traveling route in consideration of collection and delivery points of the package and boarding and drop-off points of the passenger, determines a service vehicle for package and passenger transport, and dispatches the service vehicle. When the vehicle to be dispatched is determined, the server 10 transmits information including the traveling route to the onboard terminal 40 of the dispatched service vehicle, and once the service vehicle collects the package and takes the passenger on board, the service vehicle travels on the set traveling route to deliver the package and carry the passenger to the drop-off point.

At this time, if a passenger is in the vehicle at a collection point or a delivery point of the package, the crew of the service vehicle leaves the vehicle for loading or unloading work, and only the passenger is left in the vehicle. Accordingly, trouble, such as theft of a package or the vehicle, may occur, and thus in the present embodiment, a service vehicle is set to go via the collection point and the delivery point when no passenger is on board.

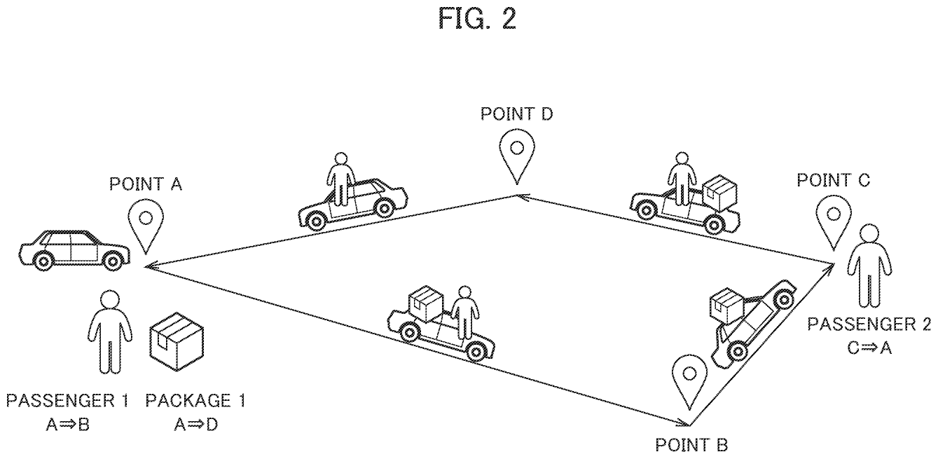

For example, as illustrated in FIG. 2, when a passenger 1 going to a point B and a package 1 going to a point D are picked up at a point A, and then a passenger 2 going from a point C to the point A is picked up, the conventional traveling route is set in the order of A→B→C→D→A in consideration of operational efficiency and the like. However, in this case, the delivery of the package 1 takes place at the point D when the passenger 2 is on board, which leads to a situation where the crew is absent from the vehicle even though the passenger is on board. As a result, there may be trouble, such as theft of a package or the vehicle.

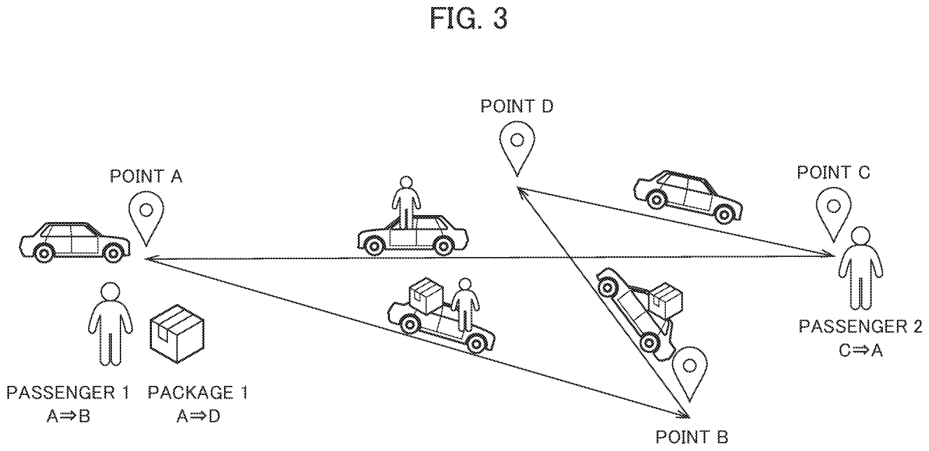

However, even in the case of transporting the same passengers 1, 2 and the package 1, if the traveling route is set in the order of A→B→C→D→A as illustrated in FIG. 3, the passenger 2 is not on board at the point D, which enables the package 1 to be delivered when no passenger is on board. Accordingly, it is possible to prevent trouble from occurring, such as theft of a package or the vehicle.

Next, the server 10 is described. The server 10 manages service vehicles for putting together and transporting packages and passengers in the combined passenger and freight transport system 1. Specifically, the server 10 receives a delivery request from the package terminal 20, receives a vehicle dispatch request from the passenger terminal 30, sets a traveling route for a service vehicle for putting together and transporting a package and a passenger, and determines a vehicle to be dispatched. As illustrated in FIG. 1, the server 10 includes a communication unit 11, a database 13, and a vehicle dispatch device 15.

The communication unit 11 has a function of transmitting and receiving information through the network. The communication unit 11 acquires predetermined information, such as a delivery request transmitted from the package terminal 20 and a vehicle dispatch request transmitted from the passenger terminal 30, through the network, and records the acquired information in the database 13. The communication unit 11 transmits information, such as a traveling route set by the vehicle dispatch device 15 and a vehicle dispatched by the vehicle dispatch device 15, through the network to the package terminal 20, the passenger terminal 30, and the onboard terminal 40.

The database 13 stores information acquired by the communication unit 11 and information necessary for dispatching a service vehicle. Specifically, the database 13 stores the delivery request acquired from the package terminal 20 and the vehicle dispatch request acquired from the passenger terminal 30, and also stores package manager information and passenger information. The database 13 stores information necessary for dispatching a service vehicle, such as vehicle information and location information of service vehicles, dispatch plan information, and also map information. Moreover, regarding package collection and delivery points, it is registered whether to require package loading and unloading work to be performed by a crew of a service vehicle at each point.

The vehicle dispatch device 15 executes vehicle dispatch processing of dispatching a service vehicle for putting together and transporting a package and a passenger. Specifically, the vehicle dispatch device 15 acquires the delivery request and the vehicle dispatch request, detects a candidate vehicle, and calculates a candidate route for the candidate vehicle to go via the collection point and the delivery point of the package when no passenger is on board. Then, the calculated candidate route is set as a traveling route, and the candidate vehicle of the candidate route set as the traveling route is dispatched as the service vehicle. The vehicle dispatch device 15 includes a request acquisition unit 51, a candidate vehicle detection unit 53, a candidate route calculation unit 55, and a vehicle dispatch determination unit 57.

The request acquisition unit 51 acquires the delivery request and the vehicle dispatch request from the package terminal 20 and the passenger terminal 30 through the communication unit 11. The delivery request includes at least a collection point and a delivery point of a package, and also includes information on the manager of the package, contents of the package (weight, type), a desired collection time, and a desired delivery time. The vehicle dispatch request includes at least a boarding point and a drop-off point of a passenger, and also includes information, such as the number of passengers, the presence or absence of packages, a desired boarding time, and a desired drop-off time.

The candidate vehicle detection unit 53 detects a candidate vehicle, as a candidate of a service vehicle for package and passenger transport, based on the collection point of the package or the boarding point of the passenger acquired by the request acquisition unit 51. Specifically, the candidate vehicle detection unit 53 detects all service vehicles within a predetermined range (for example, within several kilometers) from the package collection point or the passenger boarding point as candidate vehicles.

For the candidate vehicle detected by the candidate vehicle detection unit 53, the candidate route calculation unit 55 calculates a candidate route where the candidate vehicle goes via the collection point and the delivery point of the package when no passenger is on board, based on the delivery request and the vehicle dispatch request. Specifically, the candidate route calculation unit 55 calculates all candidate routes via the package collection and delivery points and the passenger boarding and drop-off points by changing the order of passage.

The candidate route calculation unit 55 selects a candidate route via the collection point and the delivery point of the package with no passenger on board from the calculated candidate routes. However, a candidate route including a collection point and a delivery point requiring no loading and unloading work of packages by a crew of a service vehicle may be selected as a candidate route even when the collection point and the delivery point are passed when a passenger is on board.

The vehicle dispatch determination unit 57 sets the candidate route calculated by the candidate route calculation unit 55 as a traveling route for transporting a package and a passenger, and dispatches the candidate vehicle of the candidate route set as the traveling route, as the service vehicle for transporting the package and the passenger. Note that, when multiple candidate routes are calculated by the candidate route calculation unit 55, a candidate route having the best traveling condition of the candidate vehicle is set as the traveling route from the calculated candidate routes.

Note that the vehicle dispatch device 15 is a controller including a general-purpose electronic circuit including a microcomputer, a microprocessor, or a CPU, and a peripheral device, such as a memory, and has a function of dispatching a service vehicle in the combined passenger and freight transport system 1. Each function of the vehicle dispatch device 15 may be implemented by one or more processing circuits. The processing circuit includes a programmed processing device, such as a processing device including an electrical circuit, and also includes an application specific integrated circuit (ASIC) arranged to perform the functions described in embodiments and a device, such as a conventional circuit component.

Next, the package terminal 20 is described. The package terminal 20 is a device that can access the server 10 through the network and is, for example, a personal computer installed in a business office of a delivery company or a commercial facility, or a portable terminal (smartphone, tablet, etc.) used by a user on a daily basis. The package terminal 20 has an application installed necessary to execute the package delivery service provided by the combined passenger and freight transport system 1. Accordingly, the package terminal 20 can transmit necessary information to the server 10 and can receive and display the information transmitted by the server 10. As illustrated in FIG. 1, the package terminal 20 includes a communication unit 21, a controller 23, and an input unit 25.

The communication unit 21 has a function of transmitting and receiving information to and from the server 10 through the network, stores the received information in a memory or the like (not shown), and transmits predetermined information, such as a delivery request. For example, the communication unit 21 may be a device provided with a mobile communication function, such as 50.

The controller 23 receives a package delivery request based on an operation to the input unit 25 by a package manager. In addition to collection and delivery points of a package, the type of the package, the size of the package, the number of packages, and the like, are input when the delivery request is input.

Note that the controller 23 is a general-purpose microcomputer including a CPU (central processing unit), a memory, and an input and output unit. The controller 23 has a computer program installed to function as a part of the package terminal 20. By executing the computer program, the controller 23 controls the communication unit 21. Various types of information processing provided in the controller 23 may be realized by software or dedicated hardware.

The input unit 25 is an input interface for receiving an operation from a package manager. For example, the input unit 25 may be a device operated using multiple buttons or a touch panel.

Next, the passenger terminal 30 is described. The passenger terminal 30 is a device capable of accessing the server 10 through the network and is, for example, a personal computer installed in a commercial facility or a portable terminal (smartphone, tablet, etc.) used by a user on a daily basis. The passenger terminal 30 has an application installed necessary to execute the passenger transport service provided by the combined passenger and freight transport system 1. Thus, the passenger terminal 30 can transmit necessary information to the server 10 and can receive and display the information transmitted by the server 10. As illustrated in FIG. 1, the passenger terminal 30 includes a communication unit 31, a controller 33, and an input unit 35.

The communication unit 31 has a function of transmitting and receiving information to and from the server 10 through the network, stores the received information in a memory or the like (not shown), and transmits predetermined information, such as a vehicle dispatch request. For example, the communication unit 31 may be a device provided with a mobile communication function, such as 5G.

The controller 33 receives a vehicle dispatch request from a passenger based on an operation to the input unit 35 by the passenger. During the input of the vehicle dispatch request, the number of passengers and the presence or absence of packages are input in addition to boarding and drop-off points of the passenger.

Note that the controller 33 is a general-purpose microcomputer including a CPU (central processing unit), a memory, and an input and output unit. The controller 33 has a computer program installed to function as a part of the passenger terminal 30. By executing the computer program, the controller 33 controls the communication unit 31, Various types of information processing provided in the controller 33 may be realized by software or dedicated hardware.

The input unit 35 is an input interface for receiving an operation from a passenger. For example, the input unit 35 may be a device operated using multiple buttons or a touch panel.

Next, the onboard terminal 40 is described. The onboard terminal 40 is mounted on a service vehicle for putting a package and a passenger together and can access the server 10 through the network. The onboard terminal 40 has an application installed necessary to execute a service for putting together and transporting a package and a passenger in the combined passenger and freight transport service 1. Thus, the onboard terminal 40 can transmit necessary information to the server 10 and can receive and display the information transmitted by the server 10. As illustrated in FIG. 1, the onboard terminal 40 includes a communication unit 41, a controller 43, and a display unit 45.

The communication unit 41 has a function of transmitting and receiving information to and from the server 10 through the network, stores the received information in a memory or the like (not shown), and transmits predetermined information, such as location information of the service vehicle. For example, the communication unit 41 may be a device provided with a mobile communication function, such as 5G.

The controller 43 displays a traveling route transmitted by the server 10 on the display unit 45 and instructs the driver of the service vehicle on the traveling route. The controller 43 periodically transmits the location information of the service vehicle to the server 10.

The controller 43 is a general-purpose microcomputer including a CPU (central processing unit), a memory, and an input and output unit. The controller 43 has a computer program installed to function as a part of the onboard terminal 40. By executing the computer program, the controller 43 controls the communication unit 41. Various types of information processing provided in the controller 43 may be realized by software or dedicated hardware.

The display unit 45 is a display device for displaying an instruction from the server 10 and is, for example, a display of a navigation device mounted on the service vehicle.

### Method of Dispatching Service Vehicle

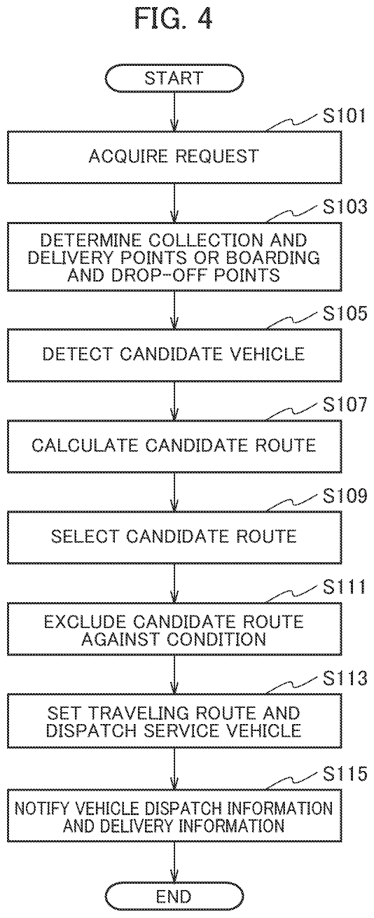

Next, a method of dispatching a service vehicle by the vehicle dispatch device 15 of the combined passenger and freight transport system 1 according to the present embodiment is described. FIG. 4 is a flowchart illustrating a processing procedure of vehicle dispatch processing of a service vehicle by the vehicle dispatch device 15 according to the present embodiment. Note that the service vehicle may transport only a package or only a passenger, but this embodiment describes a case of transporting a package and a passenger at the same time. The case of transporting a package and a passenger at the same time includes a case of picking up a passenger later while a service vehicle is traveling with a package and a case of picking up a package later while a service vehicle is traveling with a passenger.

As illustrated in FIG. 4, in step S101, the request acquisition unit 51 acquires a delivery request transmitted by the package terminal 20 and a vehicle dispatch request transmitted by the passenger terminal 30 through the communication unit 11. For example, in the case where a service vehicle picks up a package first and then a passenger, the request acquisition unit 51 has already acquired a delivery request and receives a new vehicle dispatch request. In the case where a service vehicle picks up a passenger first and then a package, the request acquisition unit 51 has already acquired a vehicle dispatch request and receives a new delivery request.

In step S103, the candidate vehicle detection unit 53 determines a collection point and a delivery point of a package, or a boarding point and a drop-off point of a passenger. For example, when a delivery request is acquired, the delivery request specifies a collection point and a delivery point of a package, and thus the specified points are just determined as the collection point and the delivery point. However, when a service vehicle performs a service to go around predetermined stop points, a stop point near the point specified in the delivery request is determined as the collection point or the delivery point. Similarly, when a vehicle dispatch request is received, the boarding point and the drop-off point of the passenger are determined based on a hoarding point and a drop-off point specified in the vehicle dispatch request.

For example, when a new vehicle dispatch request is acquired while a service vehicle is transporting a package, a boarding point and a drop-off point of a passenger are determined. When a new delivery request is acquired while a service vehicle is transporting a passenger, a collection point and a delivery point of a package are determined.

In step S105, the candidate vehicle detection unit 53 detects a candidate vehicle as a candidate for a service vehicle that transports a package and a passenger, based on the collection point of the package or the boarding point of the passenger determined in step S103.

For example, when a new vehicle dispatch request is acquired while a service vehicle is transporting a package, all service vehicles within a predetermined range (for example, within several kilometers) from the passenger boarding point are detected. When a new delivery request is acquired while a service vehicle is transporting a passenger, all service vehicles within a predetermined range from the package collection point are detected. Note that when multiple delivery requests or multiple vehicle dispatch requests are received, all service vehicles within a predetermined range from a point where a collection scheduled time or a boarding scheduled time is the earliest are detected.

In step S107, the candidate route calculation unit 55 calculates a candidate route for the candidate vehicle detected in step S105, based on the delivery request and the vehicle dispatch request. Specifically, since the collection point and the delivery point are specified in the delivery request, and the boarding point and the drop-off point are specified in the vehicle dispatch request, all the candidate routes connecting these points are calculated by changing the order of the respective points. When multiple candidate vehicles are detected, a candidate route is calculated for each of the candidate vehicles. Further, when multiple delivery requests and multiple dispatch requests are received, all candidate routes connecting all of the collection points, delivery points, boarding points, and drop-off points included in the requests are calculated.

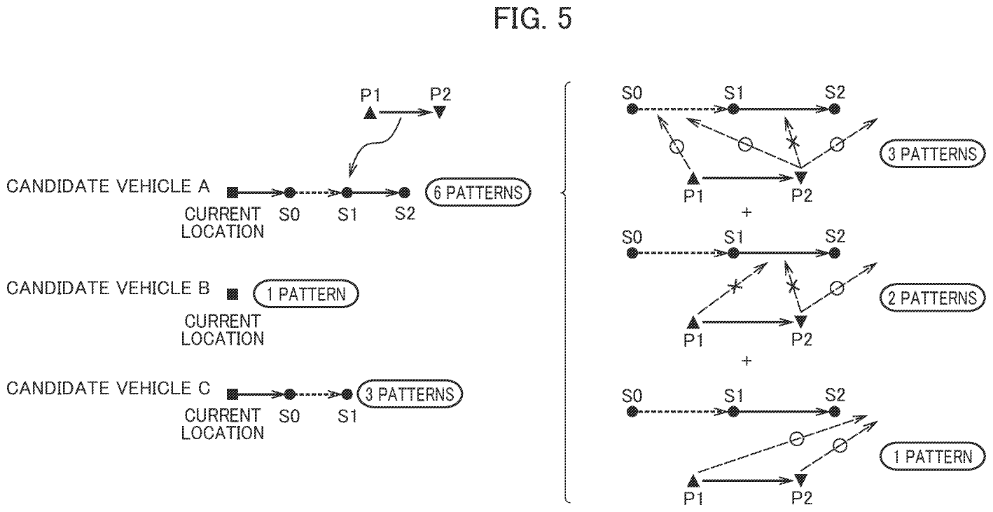

For example, as illustrated in FIG. 5, a case is described where a delivery request for transporting a package from a collection point P1 to a delivery point P2 is received, and three candidate vehicles A, B, and C are detected. The candidate vehicle A is traveling with a passenger on board at the current location, and after the passenger gets off at a point S0, the candidate vehicle A moves to a point S1 without passengers and will travel with another passenger on board from the point S1 to a point S2. In FIG. 5, a dotted arrow indicates without passengers, and a solid arrow indicates with passengers. When a new delivery request is received here, and a package is to be delivered from the collection point P1 to the delivery point P2, the candidate routes are six patterns in FIG. 5.

That is, when the collection point P1 is arranged between the points S0 and S1, the delivery point P2 can be arranged in three patterns: between the points S0 and S1, between the points S1 and S2, and after the point S2. Since the vehicle is currently traveling between the current location and the point S0, the collection point P1 is not arranged therebetween. When the collection point P1 is arranged between the points S1 and S2, the delivery point P2 can be arranged in two patterns: between the points S1 and S2, and after the point S2. Furthermore, when the collection point P1 is arranged after the point S2, the delivery point P2 can be arranged only after the point 52. Thus, 3+2+1=6 patterns can be calculated as the candidate routes for the candidate vehicle A.

Next, since the candidate vehicle B has no passenger on board at the current location, when the candidate vehicle B receives a new delivery request to transport a package from the collection point P1 to the delivery point P2, the candidate vehicle B just goes from the current location to the collection point P1, takes the package, and travels to the delivery point P2. Thus, only one pattern is calculated as the candidate route for the candidate vehicle B.

Moreover, the candidate vehicle C is traveling with a passenger on board at the current location, and will travel without passengers to the point S1 after the passenger gets off at the point S0. When a new delivery request is received here, and a package is to be transported from the collection point P1 to the delivery point P2, the candidate routes are three patterns.

That is, when the collection point P1 is arranged between the points S0 and S1, the delivery point P2 can be arranged in two patterns: between the points S0 and S1, and after the point S1. When the collection point P1 is arranged after the point S1, the delivery point P2 can be arranged only after the point S1. Thus, 2+1=3 patterns can be calculated as the candidate routes for the candidate vehicle C.

In the case of FIG. 5 where the three candidate vehicles A, B, and C are detected as described above, +1+3=10 patterns can be calculated as the candidate routes. When the candidate routes are calculated in this way, the candidate route calculation unit 55 calculates a traveling distance and a traveling time for each of the candidate routes. Although FIG. 5 illustrates a case where a service vehicle is transporting a passenger, and a package is to be picked up later, it is also possible to calculate a candidate route similarly in a case where a service vehicle is transporting a package, and a passenger is to be picked up later.

When the candidate route is calculated, the candidate route calculation unit 55 calculates a scheduled delivery time when the package arrives at the delivery point and calculates a delivery time limit by adding a predetermined allowable time delay to the calculated scheduled delivery time. Similarly, a scheduled drop-off time when the passenger arrives at the drop-off point is calculated, and a drop-off time limit is calculated by adding a predetermined allowable time delay to the calculated scheduled drop-off time.

Furthermore, when a desired delivery time is specified in the delivery request, the candidate route calculation unit 55 may calculate the delivery time limit based on the desired delivery time. Similarly, when a desired drop-off time is specified in the vehicle dispatch request, the drop-off time limit may be calculated based on the desired drop-off time. For example, the desired delivery time may be set as the delivery time limit, or the delivery time limit may be set by adding the allowable time delay to the desired delivery time. Similarly, the desired drop-off time may be set as the drop-off time limit, or the drop-off time limit may be set by adding the allowable time delay to the desired drop-off time.

Note that the allowable time delay for packages is set longer than the allowable time delay for passengers. For example, the allowable time delay for passengers is about several minutes, while the allowable time delay for packages is about several tens of minutes. If the arrival of a passenger is delayed, complaints from the passenger are great even if it is a few minutes late, but if the delivery of a package is delayed, complaints from a recipient are not so great. Thus, the allowable time delay for packages is set longer than the allowable time delay for passengers. Thus, passengers can be transported preferentially, so that the number of passengers to be transported can be increased. For example, when a new vehicle dispatch request is received from a passenger, the delivery of the package can be delayed by, for example, 30 minutes within the allowable time delay, so that the new passenger can be transported prior to the package. A longer allowable time delay makes it possible to increase the number of passengers to be transported during that time.

In step S109, the candidate route calculation unit 55 selects a candidate route where the candidate vehicle goes via the collection point and the delivery point of the package when no passenger is on board from the candidate routes calculated in step S107.

Specifically, in the case of the candidate vehicle A in FIG. 5, since a passenger is on board between the points S1 and S2, the collection point P1 and the delivery point P2 to be passed when no passenger is on board are represented by positions marked with a circle. In contrast, the collection point P1 and the delivery point P2 to be passed when a passenger is on board are represented by a position marked with an X. Among these positions, since the arrangement where both the collection point P1 and the delivery point P2 are marked with a circle has three patterns, the three patterns are selected as the candidate routes of the candidate vehicle A.

Moreover, since the candidate vehicle B has no passenger on board, the collection point P1 and the delivery point P2 are passed when no passenger is on board. Accordingly, one pattern is selected as the candidate route of the candidate vehicle B.

Furthermore, in the case of the candidate vehicle C, since the passenger gets off at the point S0, all three patterns of candidate routes of the candidate vehicle C become the candidate routes via the collection point P1 and the delivery point P2 of the package with no passenger on board. Thus, the three patterns are selected as the candidate routes of the candidate vehicle C. As a result, in the case of FIG. 5, 3+1+3=7 patterns are selected as the candidate routes.

Note that when a collection point and a delivery point are points requiring no loading and unloading work of packages by a crew, the candidate route calculation unit 55 calculates a candidate route including such the collection point and the delivery point as a candidate route even when they are passed with a passenger on board. For example, a commercial facility has personnel deployed to deliver packages, so that a service vehicle crew does not need to perform loading and unloading work of packages in such locations. Accordingly, trouble, such as theft, does not occur even when a passenger is in the service vehicle, and thus a candidate route including such a collection point and a delivery point may be calculated as a candidate route even when they are passed with a passenger on board.

Furthermore, when a package collection point and a passenger boarding point are the same point as in the point A of FIG. 3, if the passenger is set to get on the vehicle after the package is loaded, the crew will not be absent from the vehicle for collecting the package when the passenger is on board. Thus, the candidate route calculation unit 55 calculates the candidate route where the package collection point and the passenger boarding point are the same point in a case where a passenger gets on after a package is collected at the same point, as a candidate route. Accordingly, when a package and a passenger are picked up at the same point, it is possible to prevent a situation where the crew is absent from the vehicle for collecting the package even though the passenger is on board.

When a package delivery point and a passenger boarding point are the same point, the candidate route calculation unit 55 calculates the candidate route where the package delivery point and the passenger boarding point are the same point in a case where the passenger gets on after the package is delivered at the same point, as a candidate route.

Similarly, when a package delivery point and a passenger drop-off point are the same point, if the package is set to be unloaded from the vehicle after the passenger gets off the vehicle, the crew will not be absent from the vehicle for delivering the package when the passenger is on board. Thus, the candidate route calculation unit 55 calculates the candidate route where the package delivery point and the passenger drop-off point are the same point in a case where the package is delivered after the passenger gets off the vehicle at the same point, as a candidate route. Accordingly, when a package and a passenger are dropped-off at the same point, it is possible to prevent a situation where the crew is absent from the vehicle for delivering the package even though the passenger is on board.

When a package collection point and a passenger drop-off point are the same point, the candidate route calculation unit 55 calculates the candidate route where the package collection point and the passenger drop-off point are the same point in a case where the package is collected after the passenger gets off the vehicle at the same point, as a candidate route.

In step S111, the candidate route calculation unit 55 excludes candidate routes against conditions from the candidate routes selected in step S109. For example, if there is a candidate route where packages to be delivered exceed the loading capacity of the service vehicle, or a candidate route where the number of passengers exceeds the capacity of the service vehicle, such a candidate route is excluded. The candidate route calculation unit 55 also excludes a candidate route arriving at a delivery point in excess of the delivery time limit, and a candidate route arriving at a drop-off point in excess of the drop-off time limit.

In step S113, the vehicle dispatch determination unit 57 sets a candidate route selected in step S109 and not excluded in step S111, as a traveling route for transporting package and passenger. The vehicle dispatch determination unit 57 dispatches a candidate vehicle of the candidate route set as the traveling route, as a service vehicle for transporting package and passenger.

At this time, when multiple candidate routes are selected in step S109, the vehicle dispatch determination unit 57 sets a candidate route having the best traveling condition of the candidate vehicle from the selected candidate routes, as the traveling route of the service vehicle. As the traveling conditions, for example, traveling distance or traveling time of the candidate route may be set, and a candidate route having the shortest traveling distance or traveling time is set as the traveling route.

For example, in the case of FIG. 5, the candidate routes selected in step S109 are 7 patterns, of which 3 patterns for the candidate routes of the candidate vehicle A, 1 pattern for the candidate route of the candidate vehicle B, and 3 patterns for the candidate routes of the candidate vehicle C are selected. When the traveling distance of a candidate route of the candidate vehicle A is the shortest, the candidate route of the candidate vehicle A is set as the traveling route, and the candidate vehicle A is dispatched as the service vehicle.

In step S115, when a service vehicle to be dispatched is determined in step S113, the vehicle dispatch determination unit 57 notifies the manager of the package of delivery information through the package terminal 20 and notifies the passenger of the vehicle dispatch information through the passenger terminal 30. The delivery information includes information necessary for package delivery, such as a collection point, scheduled collection time, a delivery point, and scheduled delivery time of a package, and the vehicle dispatch information includes information necessary for a passenger, such as a boarding point, scheduled boarding time, a drop-off point, and scheduled drop-off time of a passenger. When the scheduled delivery time or the scheduled drop-off time is changed, notification is made again. When the delivery information and the vehicle dispatch information are notified, the vehicle dispatch processing of a service vehicle according to the present embodiment is completed.

### Variation

In the above-described embodiment, in step S109, a candidate route via the collection point and the delivery point of the package with no passenger on board is selected from the candidate routes calculated in step S107.

However, in step S109, the candidate route calculation unit 55 may select the remaining candidate routes by excluding candidate routes where a passenger is on board at a collection point and a delivery point of a package from the candidate routes calculated in step S107.

Even when such processing is performed, the candidate route to be selected is a candidate route via the collection point and the delivery point of the package with no passenger on board, as in the above-described embodiment. In an actual system, it is easier to perform the process of selecting a candidate route by performing such a process.

### Effects of First Embodiment

As described above in detail, the vehicle dispatch device 15 of the combined passenger and freight transport system 1 according to the present embodiment detects a candidate vehicle based on a collection point of a package or a boarding point of a passenger and calculates, for the candidate vehicle, a candidate route where the candidate vehicle goes via the collection point and a delivery point of the package when no passenger is on board. Then, the calculated candidate route is set as a traveling route, and the candidate vehicle of the candidate route set as the traveling route is dispatched as a service vehicle for transporting package and passenger. This prevents a situation from occurring where the crew is absent from the vehicle for collection and delivery of packages when a passenger is on hoard, thereby preventing trouble from occurring, such as theft of a package or the vehicle.

Also, the vehicle dispatch device 15 of the combined passenger and freight transport system 1 according to the present embodiment calculates candidate routes based on a delivery request and a vehicle dispatch request and selects a candidate route where the candidate vehicle goes via a collection point and a delivery point of a package when no passenger is on board from the calculated candidate routes. Thus, in an actual system, it is possible to reliably select a candidate route and to prevent a situation from occurring where the crew is absent from the vehicle for collection and delivery of packages when a passenger is on board.

Further, the vehicle dispatch device 15 of the combined passenger and freight transport system 1 according to the present embodiment calculates a candidate route where a collection point or a delivery point of a package and a boarding point of a passenger are the same point in a case where a passenger gets on the vehicle after a package is collected or delivered at the same point, as a candidate route. Thus, even when the collection point or the delivery point of the package and the passenger boarding point are the same point, it is possible to prevent a situation from occurring where the crew is absent from the vehicle for collection and delivery of packages when a passenger is on board.

Furthermore, the vehicle dispatch device 15 of the combined passenger and freight transport system 1 according to the present embodiment calculates a candidate route where a collection point or a delivery point of a package and a drop-off point of a passenger are the same point in a case where a package is collected or delivered after a passenger gets off the vehicle at the same point, as a candidate route. Thus, even when the collection point or the delivery point of the package and the passenger drop-off point are the same point, it is possible to prevent a situation from occurring where the crew is absent from the vehicle for collection and delivery of packages when a passenger is on board.

Moreover, when multiple candidate vehicles are detected, the vehicle dispatch device 15 of the combined passenger and freight transport system 1 according to the present embodiment calculates a candidate route for each of the multiple candidate vehicles. Thus, even when multiple candidate vehicles are detected, all the candidate routes can be calculated.

Moreover, when multiple candidate routes are calculated, the vehicle dispatch device 15 of the combined passenger and freight transport system 1 according to the present embodiment sets a candidate route having the best traveling condition of the candidate vehicle from the calculated multiple candidate routes, as the traveling route. This enables the service vehicle to drive on the route having the best traveling condition among the calculated candidate routes.

In the vehicle dispatch device 15 of the combined passenger and freight transport system 1 according to the present embodiment, a collection point and a delivery point are registered in advance as to whether to require loading and unloading work of a package to be performed by a crew. A candidate route including a collection point and a delivery point requiring no loading and unloading work of packages is calculated as a candidate route even when the collection point and the delivery point are passed when a passenger is on board. This makes it possible to set a better traveling route since the candidate route can be calculated in consideration of whether to require the loading and unloading work of the package to be performed at the collection point and the delivery point.

Further, the vehicle dispatch device 15 of the combined passenger and freight transport system 1 according to the present embodiment calculates a scheduled delivery time when a package arrives at a delivery point, calculates a delivery time limit by adding a predetermined allowable time delay to the scheduled delivery time, and excludes a candidate route arriving at the delivery point beyond the delivery time limit. This prevents the delivery of a package from being delayed beyond the allowable range.

Further, the vehicle dispatch device 15 of the combined passenger and freight transport system 1 according to the present embodiment calculates a scheduled drop-off time when a passenger arrives at a drop-off point, calculates a drop-off time limit by adding a predetermined allowable time delay to the scheduled drop-off time, and excludes a candidate route arriving at the drop-off point beyond the drop-off time limit. This prevents the arrival of a passenger from being delayed beyond the allowable range.

Further, in the vehicle dispatch device 15 of the combined passenger and freight transport system 1 according to the present embodiment, the allowable time delay of a package is longer than the allowable time delay of a passenger. Thus, passengers can be transported preferentially, so that the number of passengers to be transported can be increased.

In the vehicle dispatch device 15 of the combined passenger and freight transport system 1 according to the present embodiment, when a desired delivery time is specified in a delivery request, the delivery time limit is calculated based on the desired delivery time. Similarly, when a desired drop-off time is designated in a vehicle dispatch request, the drop-off time limit is calculated based on the desired drop-off time. This makes it possible to set a traveling route so as to arrive at a drop-off point or a delivery point by the desired time of a package manager or a passenger.

Moreover, when a service vehicle is dispatched, the vehicle dispatch device 15 of the combined passenger and freight transport system 1 according to the present embodiment notifies the manager of the package of the scheduled delivery time, notifies the passenger of the scheduled drop-off time, and notifies again when the scheduled delivery time or the scheduled drop-off time is changed. This makes it possible to inform a passenger of the time to arrive at a drop-off point and to inform a package manager of the time to arrive at a delivery point.

### Second Embodiment

A second embodiment to which the present invention is applied is described below with reference to the drawings. In the present embodiment, since the configuration of the combined passenger and freight transport system 1 is the same as that of FIG. 1 according to the first embodiment, the same reference numerals are given to the same elements, and the detailed description thereof is omitted.

In the first embodiment, after all the candidate routes are calculated, a candidate route via a collection point and a delivery point of a package with no passenger on board is selected from the calculated candidate routes. However, in the present embodiment, a candidate route via a collection point and a delivery point of a package with no passenger on board is directly calculated.

### Method of Dispatching Service Vehicle

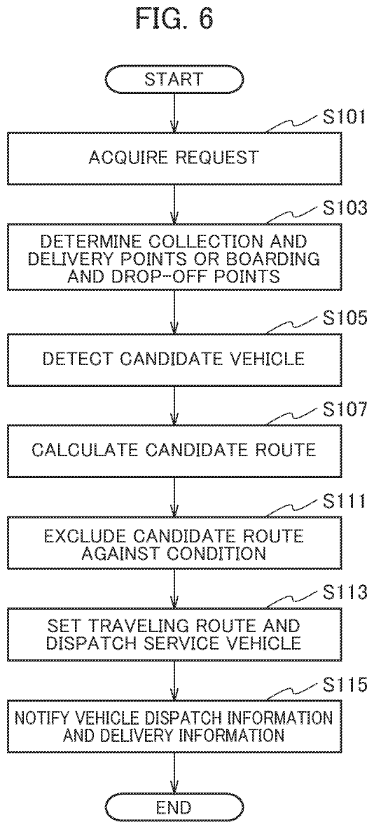

FIG. 6 is a flowchart illustrating a processing procedure of vehicle dispatch processing of a service vehicle by the vehicle dispatch device 15 according to the present embodiment. In the present embodiment, since a candidate route is directly calculated, the step of selecting a candidate route in step S109 in FIG. 4 is omitted in the flowchart of FIG. 6.

As illustrated in FIG. 6, the processes in steps S101 to S105 are performed in the same manner as in the first embodiment to detect a candidate vehicle. In step S107, the candidate route calculation unit 55 calculates a candidate route where the candidate vehicle detected in step S105 goes via the collection point and the delivery point of the package when no passenger is on board, based on the delivery request and the vehicle dispatch request.

Specifically, when a delivery request is acquired while a passenger is in the candidate vehicle, the candidate route calculation unit 55 extracts a section where the passenger is not on board on the candidate route and sets the collection point and the delivery point of the package in the extracted section.

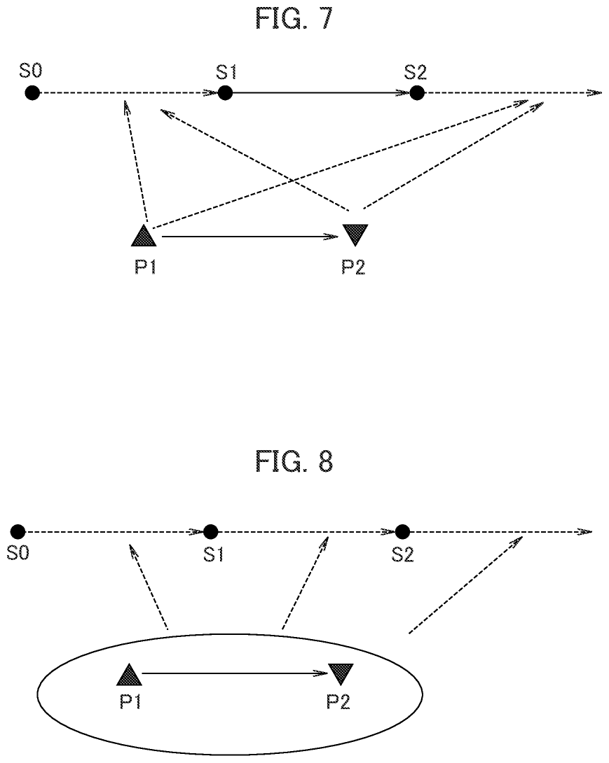

For example, as illustrated in FIG. 7, the candidate vehicle will travel from a point S0 to a point S1 without passengers, travel from the point S1 to a point S2 with a passenger on hoard, and travel from the point S2 without passengers. In FIG. 7, a dotted arrow indicates without passengers, and a solid arrow indicates with passengers. Here, a new delivery request is received, and a package is to be delivered from a collection point P1 to a delivery point P2. In this case, since the section between the points S1 and S2 is the section with a passenger on board, the candidate route calculation unit 55 extracts a section between the points S0 and S1 and a section after the point S2 as the section with no passenger on board. Then, the candidate route calculation unit 55 sets the collection point P1 and the delivery point P2 of the package in the section between the points S0 and S1 or the section after the point S2 extracted, This makes it possible to calculate a candidate route where a candidate vehicle goes via the collection points and delivery points of the package when no passenger is on board.

In contrast, when a vehicle dispatch request is acquired while a candidate vehicle delivers a package, the candidate route calculation unit 55 sets both the boarding point and the drop-off point of the passenger before the collection point of the package, between the collection points and delivery points of the package, or after the delivery point of the package.

For example, as illustrated in. FIG. 8, the candidate vehicle will travel from the point S0, collect a package at the point S1, and deliver the package to the point S2. Here, a new vehicle dispatch request is received, and a passenger is to be carried from a boarding point P1 to an drop-off point P2. In this case, the candidate route calculation unit 55 sets both the passenger boarding point P1 and drop-off point P2 before the package collection point S1, between the package collection point S1 and delivery point S2, or after the package delivery point S2. This makes it possible to calculate a candidate route where a candidate vehicle goes via the collection point and the delivery point of the package when no passenger is on board.

After the candidate route is calculated in step S107, the processes in steps S111 to S115 are performed in the same manner as in the first embodiment, and the vehicle dispatch processing of the service vehicle according to the present embodiment is completed.

### Effects of Second Embodiment

As described above in detail, in the vehicle dispatch device 15 of the combined passenger and freight transport system 1 according to the present embodiment, when a delivery request is acquired while a passenger is in a candidate vehicle, a section where the passenger is not on board on the candidate route is extracted, and the collection point and the delivery point of the package are set in the extracted section. This makes it possible to reduce the load of the server 10 since the candidate route via the collection point and the delivery point of the package with no passenger on board can be directly calculated.

Further, in the vehicle dispatch device 15 of the combined passenger and freight transport system 1 according to the present embodiment, when a vehicle dispatch request is acquired while the candidate vehicle delivers a package, both the boarding point and the drop-off point of the passenger are set before the collection point of the package, between the collection point and the delivery point of the package, or after the delivery point of the package. This makes it possible to reduce the load of the server 10 since the candidate route via the collection point and the delivery point of the package with no passenger on board can be directly calculated.

The above-described embodiments are examples of the present invention. Thus, the present invention is not limited to the above-described embodiments, and it is obvious that various modifications are possible in accordance with the design or the like even in the other embodiments as long as they do not deviate from the technical idea of the present invention.

### REFERENCE SIGNS LIST

1 Combined passenger and freight transport system

10 Server

11, 21, 31, 41 Communication unit

13 Database

15 Vehicle dispatch device

23, 33, 43 Controller

20 Package terminal

30 Passenger terminal

35 Input unit

40 Onboard terminal

45 Display unit

51 Request acquisition unit

53 Candidate vehicle detection unit

55 Candidate route calculation unit

57 Vehicle dispatch determination unit

1. A vehicle dispatch device for dispatching a service vehicle in a combined passenger and freight transport system where a package and a passenger are put together and transported by the service vehicle, and a crew of the service vehicle performs collection and delivery work of the package, the vehicle dispatch device in the combined passenger and freight transport system comprising:
a controller configured to:
to acquire a delivery request including at least a collection point and a delivery point of the package and a vehicle dispatch request including at least a boarding point and a drop-off point of the passenger;
detect a candidate vehicle as a candidate of a service vehicle for transporting the package and the passenger, based on the collection point of the package or the boarding point of the passenger;
calculate a candidate route where the candidate vehicle goes via the collection point and the delivery point of the package when the passenger is not on board, based on the delivery request and the vehicle dispatch request, for the detected candidate vehicle; and
set the calculated candidate route, as a traveling route for transporting the package and the passenger and to dispatch the candidate vehicle of the candidate route set as the traveling route, as the service vehicle for transporting the package and the passenger.

2. The vehicle dispatch device in the combined passenger and freight transport system according to claim 1,
wherein the controller calculates candidate routes based on the delivery request and the vehicle dispatch request and selects the candidate route where the candidate vehicle goes via the collection point and the delivery point of the package when the passenger is not on board from the candidate routes that have been calculated.

3. The vehicle dispatch device in the combined passenger and freight transport system according to claim 1,
wherein when the delivery request is acquired while a passenger is in the candidate vehicle, the controller extracts a section where the passenger is not on board on the candidate route and sets the collection point and the delivery point of the package in the section that has been extracted.

4. The vehicle dispatch device in the combined passenger and freight transport system according to claim 1,
wherein when the vehicle dispatch request is acquired while the candidate vehicle delivers a package, the controller sets both the boarding point and the drop-off point of the passenger before the collection point of the package, between the collection point and the delivery point of the package, or after the delivery point of the package.

5. The vehicle dispatch device in the combined passenger and freight transport system according to claim 1,
wherein the controller calculates, as the candidate route, a candidate route where the collection point or the delivery point of the package and the boarding point of the passenger are a same point in a case where the passenger gets on after the package is collected or delivered at the same point.

6. The vehicle dispatch device in the combined passenger and freight transport system according to claim 1,
wherein the controller calculates, as the candidate route, a candidate route where the collection point or the delivery point of the package and the drop-off point of the passenger are a same point in a case where the package is collected or delivered after the passenger gets off at the same point.

7. The vehicle dispatch device in the combined passenger and freight transport system according to claim 1,
wherein when the controller detects a plurality of candidate vehicles, the controller calculates the candidate route for each of the plurality of candidate vehicles.

8. The vehicle dispatch device in the combined passenger and freight transport system according to claim 1,
wherein when the controller calculates a plurality of candidate routes, the controller sets, as the traveling route, a candidate route having a best traveling condition of the candidate vehicle from the plurality of candidate routes that have been calculated.

9. The vehicle dispatch device in the combined passenger and freight transport system according to claim 1,
wherein the collection point and the delivery point are registered in advance as to whether to require loading and unloading work of the package to be performed by the crew, and
the controller calculates, as the candidate route, a candidate route including the collection point and the delivery point not requiring the loading and unloading work of the package, even when the collection point and the delivery point are passed when the passenger is on board.

10. The vehicle dispatch device in the combined passenger and freight transport system according to claim 1,
wherein the controller calculates a scheduled delivery time when the package arrives at the delivery point, calculates a delivery time limit by adding a predetermined allowable time delay to the scheduled delivery time that has been calculated, and excludes a candidate route arriving at the delivery point beyond the delivery time limit.

11. The vehicle dispatch device in the combined passenger and freight transport system according to claim 10,
wherein the controller calculates a scheduled drop-off time when the passenger arrives at the drop-off point, calculates a drop-off time limit by adding a predetermined allowable time delay to the scheduled drop-off time that has been calculated, and excludes a candidate route arriving at the drop-off point beyond the drop-off time limit.

12. The vehicle dispatch device in the combined passenger and freight transport system according to claim 11,
wherein the allowable time delay of the package is longer than the allowable time delay of the passenger.

13. The vehicle dispatch device in the combined passenger and freight transport system according to claim 11,
wherein when a desired delivery time is specified in the delivery request, the controller calculates the delivery time limit based on the desired delivery time, and when a desired drop-off time is specified in the vehicle dispatch request, the controller calculates the drop-off time limit based on the desired drop-off time.

14. The vehicle dispatch device in the combined passenger and freight transport system according to claim 11,
wherein when dispatching the service vehicle, the controller notifies a manager of the package of the scheduled delivery time, notifies the passenger of the scheduled drop-off time, and notifies again when the scheduled delivery time or the scheduled drop-off time is changed.

15. A vehicle dispatch method of dispatching a service vehicle by a server in a combined passenger and freight transport system where a package and a passenger are put together and transported by the service vehicle, and a crew of the service vehicle performs collection and delivery work of the package, the vehicle dispatch method in the combined passenger and freight transport system comprising:
acquiring a delivery request including at least a collection point and a delivery point of the package and a vehicle dispatch request including at least a boarding point and a drop-off point of the passenger;
detecting a candidate vehicle as a candidate of a service vehicle for transporting the package and the passenger, based on the collection point of the package or the boarding point of the passenger that has been acquired;
calculating a candidate route where the candidate vehicle goes via the collection point and the delivery point of the package when the passenger is not on board, based on the delivery request and the vehicle dispatch request, for the candidate vehicle that has been detected;
setting the candidate route that has been calculated, as a traveling route for transporting the package and the passenger; and
dispatching the candidate vehicle of the candidate route set as the traveling route, as the service vehicle for transporting the package and the passenger, by the server.

16. A combined passenger and freight transport system where a package and a passenger are put together and transported by a service vehicle, and a crew of the service vehicle performs collection and delivery work of the package, the system comprising:
a server configured to dispatch the service vehicle;
a package terminal configured to transmit a delivery request including at least a collection point and a delivery point of the package;
a passenger terminal configured to transmit a vehicle dispatch request including at least a boarding point and a drop-off point of the passenger; and
an onboard terminal configured to be mounted on the service vehicle, wherein the server is configured to:
acquire the delivery request and the vehicle dispatch request;
detect a candidate vehicle as a candidate of a service vehicle for transporting the package and the passenger, based on the collection point of the package or the boarding point of the passenger that has been acquired;
calculate a candidate route where the candidate vehicle goes via the collection point and the delivery point of the package when the passenger is not on board, based on the delivery request and the vehicle dispatch request, for the candidate vehicle that has been detected; and
set the candidate route that has been calculated, as a traveling route for transporting the package and the passenger and dispatch the candidate vehicle of the candidate route set as the traveling route, as the service vehicle for transporting the package and the passenger.

17. A traveling route setting device for setting a traveling route of a service vehicle for transporting a package and a passenger, the traveling route setting device comprising:
a controller configured to:
acquire a delivery data including at least a collection point and a delivery point of the package and a vehicle dispatch data including at least a boarding point and a drop-off point of the passenger;
calculate a candidate route where the service vehicle goes via the collection point and the delivery point of the package when the passenger is not on board, based on the delivery data and the vehicle dispatch data; and
set the calculated candidate route as a traveling route for transporting the package and the passenger.
